(19) United States
(12) Patent Application Publication
(10) Pub. No.: US 2002/0128924 A1
(43) Pub. Date: Sep. 12, 2002

(54) Method of ordering and dispatching articles

(76) Inventors: Walter Rosenbaum, Paris (FR); Karl Reich, Radolfzell (DE)

Correspondence Address: YOUNG & THOMPSON, 745 SOUTH 23RD STREET 2ND FLOOR, ARLINGTON, VA, 22202

(21) Appl. No.: 10/006,358

(22) Filed: Dec. 10, 2001

(30) Foreign Application Priority Data
Dec. 9, 2000 (DE) 100 61 508.2

(51) Int. Cl. G06F 17/60

(52) U.S. Cl. 705/26

(57) ABSTRACT

Method of ordering and dispatching articles An electronically transmitted purchase order is registered at an online provider (2). He then sends an order with data for a code relating to the purchase order electronically to a corresponding manufacturer or supplier (3). Following the production and/or provision of the ordered articles in neutral packaging (3.1) provided with the code, they are dispatched to a service center (6). Furthermore, the online provider (2) sends an electronic instruction to print corresponding labels with the recipient address and, if required, an invoice, a delivery note and letters and information documents in the online provider layout, with the digital data needed for this purpose and data for the code, to a print center (4) of the service center (6). In the service center (6), the articles and the printed-out documents are put together in accordance with the code and, after preparation for dispatch, are sent to the purchaser as packages (6.1) in the online provider layout.

The invention relates to a method of ordering and dispatching articles, in which the purchaser sends a purchase order via an electronic network to an online provider, who registers and stores the purchase order.

According to the prior art, the online provider, in the event of a wide range of supplies, needs a very large warehouse, from which the ordered goods are called up, combined with invoices, customer information, letters and so on, are packed, provided with labels which contain address information and are then dispatched. The printed documents, packaging and labels are implemented in the layout of the relevant online provider. In the case of a wide range of supplies, such a large, always filled store is very complicated and needs a stock of goods which ties up a considerable amount of money, so that the economy of the online provider is no longer ensured.

In order to reduce the large stock of goods, the online provider triggers electronic orders with appropriate manufacturers/suppliers on the basis of the purchase orders that have come in. Said manufacturers/suppliers then produce the ordered goods as required, or take them from a store with the limited supply profile. The goods are then packaged neutrally and dispatched to the purchaser at the online provider. Dispatch desired by the online provider, with invoices, letters, customer information, packaging, labels from the online provider in his layout cannot be implemented by the respective manufacturer/supplier.

The invention specified in claim 1 is therefore based on the object of providing a method of ordering and dispatching articles with the aid of an online provider with which the articles ordered by the purchaser can be supplied to the purchaser cost-effectively with printed documents, such as invoice, letter, information and so on and, if required, packaging in the layout of the online provider, even if the articles are not in store at the online provider himself.

According to the invention, print jobs relating to printing labels and, if required, invoices, letters, information documents and packaging materials in the online provider layout, with the digital data needed for this purpose and with digital data for a code for identifying the purchase order, are sent by the online provider to a print center of a service center by an electronic route, in accordance with the purchase order. Furthermore, an electronic order with data for a code for identifying the purchase order is sent to one or more manufacturers or suppliers by the online provider, in accordance with the purchase order.

At this service center, the articles are dispatched by the manufacturers or suppliers in neutral packaging, on which the code for the purchase order is located. After the print jobs have been completed, the article or articles with the associated printed-out documents are put together in accordance with the code, prepared for dispatch in the online provider layout and dispatched to the purchaser.

It is advantageous to apply the code in machine-readable form, for example as a bar code, to the neutral packaging, so that detection with appropriate bar code readers can be implemented quickly and cost-effectively. Instead or in addition, the code can also be applied so as to be legible to a person, so that part-automatic solutions can also be implemented, for example operation even without a bar code reader or in the event of faults in the bar code readers is possible.

By using this procedure, it is possible to send articles ordered from the online provider to the purchaser with documents, such as invoices, additional information, letters, labels in the online provider layout cost-effectively, that is to say even if the articles are not in store at the online provider, but are ordered from various manufacturers/suppliers.

The invention will now be described in more detail using an exemplary embodiment. In the drawing:

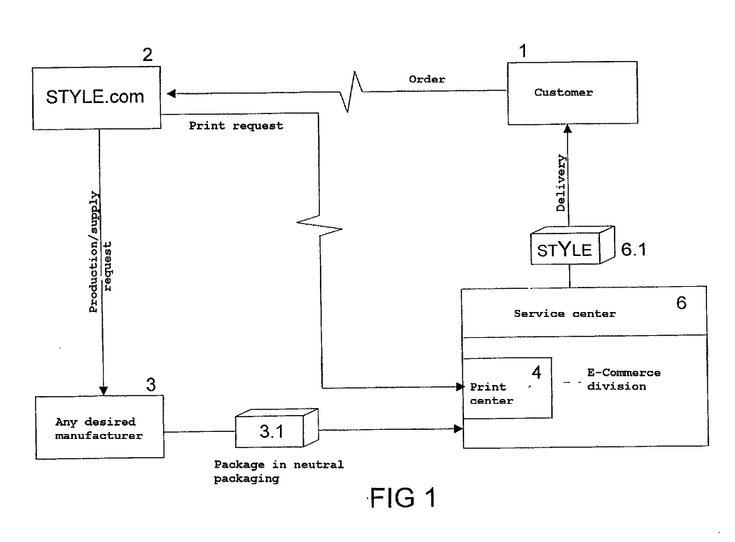

FIG. 1 shows the method sequence in a schematic representation.

According to FIG. 1, the purchaser or customer 1 places a purchase order at his Internet access (PC) and sends it to an online provider 2 with the name STYLE.com. There, the purchase order is registered and stored with the allocation of a code. Then, a print job for the fast laser color printing of one or more labels for the online provider 2, with recipient address and invoice if required, a delivery note and letters and information documents, and appropriate packaging paper in the layout of the online provider 2, is sent via an electronic network to a print center 4 of a service center 6 having an E-Commerce division 5. The digital data needed for this purpose and the digital data for the code belonging to the purchase order are also contained in the electronic print job.

The documents printed out on a fast laser color printer are then put into transport containers which are associated with the codes. Here, the transport containers can have the respective codes as a bar code and in a form that can be read by a person, or they have fixed numbers (reusable transport containers), to which the codes have to be assigned with the aid of a display.

In addition to the print job, an electronic ordering operation from one or more manufacturers or suppliers 3 is also initiated by the online provider 2. This order likewise contains data for the code belonging to the purchase order. After the production or provision of the article or articles, they are packaged neutrally, the packaging being provided with the code in bar code form and in legible form. The neutrally packaged package 3.1, addressed appropriately, is sent to the service center 6 with the E-Commerce division 5. There, by using the codes, the printed-out documents are assigned to the articles and preparation for dispatch is carried out, that is to say the printed materials are enclosed, the final packaging is carried out, if appropriate in the appropriate online provider packaging paper, and the provider labels with the recipient addresses are applied. Finally, the package or packages 6.1 are dispatched to the purchaser (initiator of the purchase order) in accordance with the purchase order.

Patent claims

1. A method of ordering and dispatching articles, in which the purchaser (1) sends a purchase order via an electronic network to an online provider (2), who registers and stores the purchase order, comprising the steps:
transmission of an order by the online provider (2) in accordance with the purchase order, via an electronic network, to one or more manufacturers or suppliers (3), with data for a code for identifying the purchase order, in which a service center (6) is specified as the delivery location,
production and/or provision of the article or articles ordered in neutral packaging, provided with the code, and dispatch to the service center (6),
sending an instruction to print one or more labels of the online provider with the recipient address, if required an invoice, a delivery note and letters, of information documents and of packaging paper in the online provider layout, via an electronic network, to a print center (4) as a constituent part of the service center (6), in accordance with the purchase order, with the digital data needed for this purpose and with digital data for the code for identifying the purchase order,
combining the article or articles in the service center (6) with the associated printed-out documents in accordance with the code, preparation for dispatch in the online provider layout and dispatch of the package or packages (6.1) from the service center (6) to the purchaser (1).

2. The method as claimed in claim 1, the code belonging to the purchase order being applied in form and/or in a form that can be read by a person to the envelope with the printed documents and the neutral dispatch packaging from the manufacturer/supplier (3).
